(19) United States
(12) Patent Application Publication
(10) Pub. No.: US 2008/0215210 A1
(43) Pub. Date: Sep. 4, 2008

(54) Anti-Rolling Method and System For a Vehicle and Corresponding Vehicle

(75) Inventors: Benoit Bulteau, Louvain-la-Neuve (BE); Richard Pothin, Jouars-Pontchartrain (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Boulogne-Billancourt (FR)

(21) Appl. No.: 11/994,519

(22) PCT Filed: Jun. 30, 2006
(86) PCT No.: PCT/FR2006/050658

§ 371 Date: Feb. 19, 2008

(30) Foreign Application Priority Data
Jul. 5, 2005 (FR) 0507115

(51) Int. Cl. B60W 30/04; B60G 17/016

(52) U.S. Cl. 701/38; 701/45

(57) ABSTRACT

An anti-rolling method and system for a vehicle and a corresponding vehicle. The device controlling the roll of a vehicle includes at least one actuator capable of acting on the roll, a module for estimating a state of roll based on a turn angle of front wheels of the vehicle, the anti-rolling torque applied to the vehicle, and speed of the vehicle, and a module for providing a rule of asymptotic rejection of disturbances acting on the roll.

The present invention relates to the field of control systems for land vehicles, in particular for wheeled automobile vehicles.

Automobile vehicles are traditionally provided with a chassis, a passenger compartment, and wheels attached to the chassis by a suspension mechanism, with steerable front wheels controlled by a steering wheel available to the driver in the passenger compartment of the vehicle and steerable or non-steerable rear wheels.

US document 2004/0117085 describes a yaw stability control system for a vehicle, equipped with a lateral acceleration sensor, a roll sensor, a steering angle sensor and at least one speed sensor supplying information to a yaw stability control unit, a roll stability control unit and a priority and integration function unit capable of controlling an active suspension system and an active roll-bar system.

US document 2004/0117071 describes a method for limiting vehicle roll with a correction of proportional, derivative and double derivative type and a control signal sent to a braking control system or sent to a steering control system.

However, these systems necessitate numerous sensors and do not achieve sufficiently stable behavior of the vehicle during certain maneuvers of the driver or under certain road conditions. Some situations may cause a loss of control of the vehicle, for example while avoiding a single or double obstacle. The losses of control in such a case are often due to a vehicle response which is inappropriate because it is too sudden, not sufficiently damped or else not very predictable.

The object of the invention is an anti-rollover control system that ensures safety, a feeling of safety, comfort and increased driving pleasure.

The roll-control method for a vehicle equipped with at least one actuator capable of acting on the roll comprises the following steps: estimating a roll state from the steering angle of the front wheels, from the anti-rollover torque applied to the vehicle and from the speed, and formulating a setpoint for asymptotic rejection of perturbations acting on the roll. In this way the perturbations can be rejected effectively, thus permitting increased vehicle stability.

Advantageously, the roll state is estimated as a function of the actuator setpoint and of the steering angle.

Advantageously, the roll state is estimated as a function of the actuator dynamics.

Advantageously, the evolution of the roll state is calculated as a function of a perturbation.

In one embodiment, the roll angle is measured by a sensor, and the roll state is estimated from the measured roll angle.

In one embodiment, the setpoint is formulated as a function of the vehicle speed.

The roll-control device of a vehicle comprises at least one actuator capable of acting on the roll, a module for estimating a roll state from the steering angle of the front wheels, from the anti-rollover torque applied to the vehicle and from the speed, and a module for estimating a setpoint for asymptotic rejection of perturbations acting on the roll.

In one embodiment, the modules are disposed in a closed loop.

In one embodiment, the actuator is connected to an adjustable anti-roll bar.

In one embodiment, the actuator is connected to an active suspension.

The vehicle is provided with a chassis, at least three wheels attached to the chassis and a device for vehicle roll control. The device comprises at least one actuator capable of acting on the roll, a module for estimating a roll state from the steering angle of the front wheels, from the anti-rollover torque applied to the vehicle and from the speed, and a module for formulating a setpoint for asymptotic rejection of perturbations acting on the roll.

The invention is applicable to vehicles with four wheels, two front and two rear, with three wheels, or even to vehicles with six or more wheels, of which at least two are steerable.

The invention permits a vehicle to adopt the most stable possible behavior, regardless of the driver's maneuver or the road condition. It is possible to allow for certain situations that tend to cause loss of control of the vehicle, such as avoiding a single or double obstacle. The invention makes it possible to reduce the risks of loss of control in cases of this type, which risks may be due to a vehicle response which is inappropriate because it is too sudden, not sufficiently damped or else not very predictable.

Furthermore, the invention permits an increase in the feeling of safety, comfort and driving pleasure.

The active anti-rollover system makes it possible, taking into account the vehicle speed, to minimize the lateral response of the vehicle to a sudden turn of the steering wheel by the driver. Optimization takes place as a function of criteria based on safety, comfort and driving pleasure.

The present invention will be better understood by studying the detailed description of some embodiments, given by way of examples that are in no way limitative and are illustrated by the attached drawings, wherein:

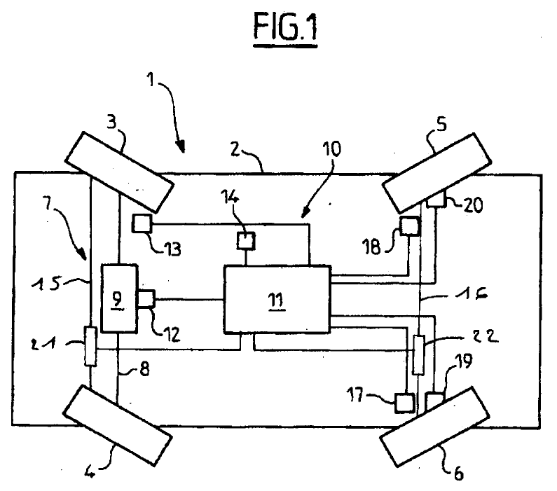

FIG. 1 is a schematic view of a vehicle equipped with a control system according to one aspect of the invention; and

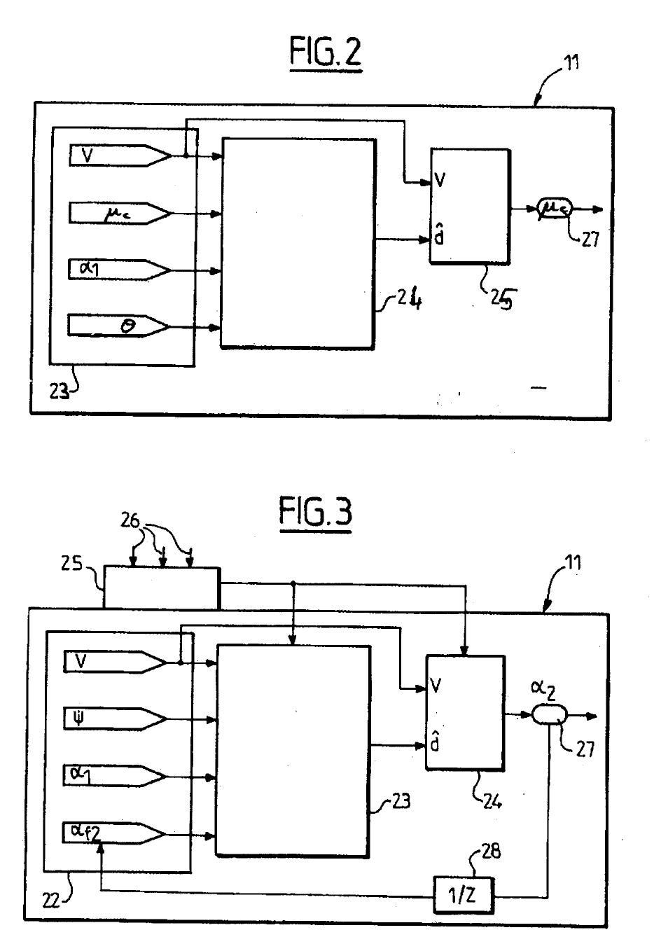

FIG. 2 is a logic diagram of the system according to one aspect of the invention.

As is evident in FIG. 1, vehicle 1 comprises a chassis 2, two front steerable wheels 3 and 4 and two rear wheels 5 and 6, the wheels being attached to chassis 2 by a suspension mechanism not illustrated.

Vehicle 1 is supplemented by a steering system 7 comprising a rack 8 disposed between front wheels 3 and 4, a rack actuator 9 capable of orienting front wheels 3 and 4 by means of rack 8 as a function of commands received mechanically or electrically from a steering wheel, not illustrated, available to the vehicle driver.

Anti-rollover control system 10 comprises a control unit 11, a sensor 12 for the steering position of front wheels 3 and 4, which sensor is mounted on actuator 9, for example, a sensor 13 for the speed of rotation of the wheels, for example the front wheels, making it possible to determine the vehicle speed V, and a sensor 14 for the roll angle θ of the vehicle, or in other words the inclination of the vehicle around a longitudinal axis passing through its center of gravity.

In addition, system 10 may comprise sensors 17 and 18 for the steering angle of rear wheels 5 and 6 as well as actuators 19 and 20 that permit the said rear wheels 5 and 6 to be oriented. Nevertheless, a single sensor 17 and a single actuator 19 can be sufficient for detection of the steering angle and for orienting rear wheels 5 and 6. Rear wheels 5 and 6 may be non-steerable. The position and speed sensors may be of optical or else magnetic type, for example of Hall-effect type, cooperating with an encoder integral with a movable part, while the sensor is non-revolving.

Vehicle 1 comprises two roll bars 15 and 16 connecting front wheels 3 and 4 respectively with rear wheels 5 and 6. Anti-rollover system 10 comprises at least one actuator such as represented here, two actuators 21 and 22 associated respectively with front and rear roll bars 15 and 16 respectively and capable of acting on the said roll bars 15 and 16 to form active roll bars upon reception of a control command originating from control unit 11. Actuators 21 and 22 are capable, for example, of modifying the stiffness of roll bars 15 and 16 as a function of the setpoint received from control unit 11.

Control unit 11 can be implemented in the form of a microprocessor equipped with a random-access memory, with a read-only memory, with a central unit and with input/output interfaces for receiving information from sensors and sending instructions, in particular to anti-rollover actuators 21 and 22.

More precisely, control unit 11 comprises an input block 23 receiving the signals originating from sensors 12 to 14, and in particular the vehicle speed V, the roll angle θ and the angle α₁ of the front wheels (see FIG. 2). The vehicle speed V can be obtained by forming the average of the speed of the front wheels or of the rear wheels as measured by the sensors of a wheel anti-lock system. In this case, one sensor 13 per wheel is provided, the wheel anti-lock system comprising an output connected to an input of control unit 11 to supply the vehicle speed information. Alternatively, each sensor 13 is connected to an input of control unit 11, in which case control unit 11 forms the average of the speed of the wheels.

Control unit 11 also comprises a state observer 24 for estimating information that is not measured and is necessary for control, in particular the perturbations that act on the vehicle. Input block 23 supplies state observer 24 with the vehicle speed V, the roll angle θ and the front-wheel angle α₁. As an example, state observer 24 can be constructed from a model based on the simplified equation expressing the transfer between steering angle α₁ of the front wheels and roll angle θ of the vehicle body on the one hand, and between the torque μ_{f} applied by the anti-rollover actuator and the roll angle θ of the vehicle body on the other hand. This equation can be written, for example:

$$( {I}_{xx} + {Mh}_{0}^{2} ) \text{?} + ( \frac{{E}_{1}^{2}}{2} {c}_{1} + \frac{{E}_{2}^{2}}{2} {c}_{2} ) \text{?} + ( \frac{{E}_{1}^{2}}{2} {k}_{1} + \frac{{E}_{2}^{2}}{2} {k}_{2} - {Mgh}_{0} ) θ = {MVh}_{0} \frac{12}{L} {\text{?}}_{1} + {MV}^{2} \frac{{h}_{0}}{L} {α}_{1} + {u}_{f}$$

$$\text{?} \text{indicates text missing or illegible when filed}$$

In addition, the actuator dynamics can be introduced by distinguishing the torque u_{f} actually applied by the actuator from the control torque u_{c}. This can be expressed as follows:

$${u}_{f} = \frac{{μ}_{c}}{{τ}_{a} s + 1}$$

The equation of state associated with this model is then:

$$( \begin{matrix}\text{?} \\ \text{?} \\ \text{?}\end{matrix} ) = ( \begin{matrix}- 2 ξ {ω}_{n} & 1 & 0 \\ - {ω}_{n}^{2} & 0 & {G}_{u} \\ 0 & 0 & - \frac{1}{{τ}_{a}}\end{matrix} ) ( \begin{matrix}{θ}_{c} \\ \begin{matrix}{X}_{2 , c} \\ {u}_{f}\end{matrix}\end{matrix} ) + ( \begin{matrix}{G}_{a} τ \\ {G}_{a} \\ 0\end{matrix} ) {α}_{1} + ( \begin{matrix}0 \\ 0 \\ \frac{1}{{τ}_{a}}\end{matrix} ) {u}_{c}$$

$$y = ( \begin{matrix}1 & 0 & 0 \\ 0 & 1 & 0 \\ 0 & 0 & 1\end{matrix} ) ( \begin{matrix}{θ}_{c} \\ {X}_{2 , c} \\ {u}_{f}\end{matrix} )$$

$$with \text{:}$$

$${G}_{a} = \frac{{MV}^{2} h 0}{L ( {I}_{xx} + {Mh}_{0}^{2} )}$$

$${ω}_{n} = \sqrt{\frac{\frac{1}{2} ( {E}_{1}^{2} {k}_{1} + {E}_{2}^{2} {k}_{2} ) - {Mgh}_{0}}{{I}_{xx} + {Mh}_{0}^{2}}}$$

$$τ = \frac{{L}_{2}}{V}$$

$$ξ = \frac{1}{4} ( \frac{{E}_{1}^{2} {c}_{1} + {E}_{2}^{2} {c}_{2}}{{I}_{xx} + {Mh}_{0}^{2}} )$$

$${G}_{u} = \frac{1}{( {I}_{xx} + {Mh}_{0}^{2} )}$$

$$\text{?} \text{indicates text missing or illegible when filed}$$

y is the output under consideration and X_{2,c} is the second state of the vehicle during roll defined by X_{2,c}=2ξωₙθ_{c}+θ_{c}^{Y}−G_{α}τα₁ with y the output under consideration, M the total mass of the vehicle, Iₓₓ the inertia of the vehicle body around its roll axis, or in other words a longitudinal axis that is located higher than the ground and that can be slightly inclined toward the front, L the vehicle wheelbase, ho the height of the center of gravity of the vehicle body relative to the roll axis of the vehicle body, E₁ the path of the front axle, E₂ the path of the rear axle, α₁ the steering angle of the front wheels, θ the roll angle of the vehicle body θ_{c} the roll angle of the vehicle body as calculated by the model, θ^{Y} the roll rate of the vehicle body, θ_{c}^{Y} the roll rate of the vehicle body as calculated by the model, u_{c} the setpoint roll torque and u_{f} the roll torque filtered by the actuator dynamics and therefore actually applied, and τₐ the response time of the anti-rollover actuator.

The observer is then constructed by using the same model as basis but adding the perturbation to the model. As an example, the perturbation can be modeled as a stepwise perturbation characterized by the equation: d^{Y}=0.

The equation of evolution of the observer is then the following:

$$( \begin{matrix}\text{?} \\ \text{?} \\ \text{?} \\ \text{?}\end{matrix} ) = ( \begin{matrix}- 2 ξ {ω}_{n} & 1 & 0 & 0 \\ - {ω}_{n}^{2} & 0 & {G}_{u} & 0 \\ 0 & 0 & - \frac{1}{{τ}_{a}} & 0 \\ 0 & 0 & 0 & 0\end{matrix} ) ( \begin{matrix}{\hat{θ}}_{c} \\ {\hat{X}}_{2 , c} \\ {\hat{u}}_{f} \\ \hat{d}\end{matrix} ) + ( \begin{matrix}0 & {G}_{a} τ \\ 0 & {G}_{a} \\ \frac{1}{{τ}_{a}} & 0 \\ 0 & 0\end{matrix} ) ( \begin{matrix}{u}_{c} \\ {α}_{1}\end{matrix} ) + {K}_{obs} ( {θ}_{measured} - \hat{y} )$$

$$\hat{y} = ( \begin{matrix}1 & 0 & 0 & 1\end{matrix} ) ( \begin{matrix}{\hat{θ}}_{c} \\ {\hat{X}}_{2 , c} \\ {\hat{u}}_{f} \\ \hat{d}\end{matrix} )$$

$$\text{?} \text{indicates text missing or illegible when filed}$$

where ̂ indicates that the values are estimated.

It is pointed out that the observer depends on the speed. It must also be noted that K_{obs} is the adjustment parameter of the observer. It can be calculated for several vehicle speeds and then interpolated to obtain K_{obs}(V) and to obtain a different behavior depending on the vehicle speed.

The four estimated values \hat{θ}₂^{\dot{Y}}, \hat{X}_{2,c}^{\dot{Y}}, û_{f}^{\dot{Y}} and \hat{d}^{\dot{Y}} yield an estimate of the vehicle state that could be used by other elements of control unit 11.

Control unit 11 additionally comprises a block 25 for asymptotic rejection of perturbations. Block 25 for asymptotic rejection of perturbations makes it possible to render the perturbation \hat{d} unobservable relative to the output under consideration, generally the roll angle θ of vehicle 1. Feedback is applied to the perturbation \hat{d} estimated by state observer 24. The control expression is then:

$${u}_{rejection} = - {G}_{a} \hat{d} = - \frac{{ω}_{n}^{2}}{{G}_{u}} \hat{d}$$

where, as a reminder,

$${ω}_{n} = \sqrt{\frac{\frac{1}{2} ( {E}_{1}^{2} {k}_{1} + {E}_{2}^{2} {k}_{2} ) - {Mgh}_{0}}{{I}_{xx} + {Mh}_{0}^{2}}} and$$

$${G}_{a} = \frac{1}{{I}_{xx} + {Mh}_{0}^{2}}$$

The calculation of the gain G_{α} can be accomplished by using the traditional mathematical techniques for solving linear equations.

Control unit 11 is supplemented by an output 27, which forms the general output of the control unit and delivers the set point of torque u_{c} as well as transmits it to anti-rollover actuators 21 and 22.

The invention makes it possible to take advantage of a variation of the anti-rollover action of roll bars 15 and 16 at desired moments, especially when the vehicle is cornering, and thereby improves the road-holding ability of the vehicle and the driving comfort experienced by the driver.

1-11. (canceled)

12: A method for control of roll of a vehicle, including at least one actuator capable of acting on the roll, the method comprising:
estimating a roll state from a steering angle of front wheels of the vehicle, from anti-rollover torque applied to the vehicle, and from speed of the vehicle; and
formulating a setpoint for asymptotic rejection of perturbations acting on the roll.

13: A method according to claim 12, wherein a roll angle is calculated as a function of an actuator setpoint and of the steering angle.

14: A method according to claim 13, wherein the roll angle is calculated as a function of actuator dynamics.

15: A method according to claim 12, wherein evolution of a roll angle is calculated as a function of a perturbation.

16: A method according to claim 12, wherein evolution of a roll angle is measured by a sensor.

17: A device according to claim 12, wherein the setpoint is formulated as a function of the vehicle speed.

18: A device for control of roll of a vehicle, the device comprising:
at least one actuator capable of acting on the roll;
a module for estimating a roll state from a steering angle of front wheels of the vehicle, from anti-rollover torque applied to the vehicle, and from speed of the vehicle; and
a module for formulating a setpoint for asymptotic rejection of perturbations acting on the roll.

19: A device according to claim 18, wherein the modules are disposed in a closed loop.

20: A device according to claim 18, wherein the actuator is connected to an adjustable anti-roll bar.

21: A device according to claim 18, wherein the actuator is connected to an active suspension.

22: A vehicle comprising:
a chassis;
at least three wheels attached to the chassis; and
a device for vehicle roll control, the device comprising at least one actuator capable of acting on the roll, a module for estimating a roll state from a steering angle of front wheels of the vehicle, from anti-rollover torque applied to the vehicle, and from speed of the vehicle, and a module for formulating a setpoint for asymptotic rejection of perturbations acting on the roll.
